(19) United States
(12) Patent Application Publication
(10) Pub. No.: US 2005/0236812 A1
(43) Pub. Date: Oct. 27, 2005

(54) Wheelchair with elevating seat

(76) Inventor: Charles Basil Firth, Jesmond (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/099,989

(22) Filed: Apr. 6, 2005

(30) Foreign Application Priority Data
Apr. 7, 2004 (GB) GB0407914.1

(51) Int. Cl. B62B 1/00

(52) U.S. Cl. 280/638

(57) ABSTRACT

Apparatus for moving a seat of a wheelchair between lowered and raised positions comprises a translating mechanism having a first end and a second end, the first end of the translating mechanism being attached to a frame of the wheelchair and the seat being attached to the second end of the translating mechanism. The translating mechanism generates a translational movement of the seat that is forwards and upwards with respect to the frame of the wheelchair.

### FIELD OF THE INVENTION

The invention relates to a wheelchair with an elevating seat, and in particular to a mechanism providing for the selective positioning of a seat on a wheelchair.

### BACKGROUND OF THE INVENTION

In a conventional wheelchair the user cannot reach as high as a person can when standing because the body is at a lower level. There are many situations where a wheelchair user would benefit from being at an elevated height as if they were standing, to carry out the day to day interactions that an able bodied person would normally do when standing.

Wheelchairs that enable the user to interact at an elevated height are well known in the art.

Wheelchairs incorporating stand-up mechanisms, or mechanisms that allow for positioning of the seat in an elevated position enabling users to interact at an increased height, have been proposed. Such wheel chairs often require heavy mechanisms and or electric actuating motors which in turn require batteries such that the weight of the wheelchair increases and it becomes expensive and more limited in its versatility. If electric motors and batteries are not used the actuation must be achieved by the user which requires a separate mechanism and a substantial amount of energy to effect the translation

One such device, described in U.S. Pat. No. 5,108,202 (Smith), incorporates a hydraulic cylinder and a manually operated hydraulic pump assembly to raise the chair to a height where the user's body is at the height that it might be if he was in the standing position.

Another feature of known designs is that the change in energy of the user as he lowers himself from the elevated position to the seated position is lost.

It would therefore be desirable to develop a wheelchair with an elevating seat that does not suffer from the disadvantages associated with the above-described prior art devices.

### SUMMARY OF THE INVENTION

According to one aspect of the invention there is provided apparatus for moving a seat of a wheelchair between lowered and raised positions as specified in claim 1.

According to another aspect of the invention there is provided a wheelchair as specified in claim 27.

The present invention overcomes the limitations of the existing devices by providing a wheelchair with a lightweight mechanism that allows a user to easily and quickly move himself to and from an elevated height. At the elevated height the user adopts a “mounted” stance on a saddle type seat.

When seated, the upper leg (the femur) lies generally horizontally whilst the lower leg (the tibia) lies vertically. It is desirable that the translating mechanism connecting the seat and the frame is such that the seat is elevated to a position that orients the femur at a comfortable angle of approximately 45 degrees to the horizontal, whilst keeping the tibia generally vertical. The geometric requirements to create this feature are such that the position of the seat must be translated forward as well as vertically upward.

This simultaneous forward and upward motion may be conveniently achieved by connecting the seat to the framework of the wheelchair using one or more straight linear telescopic slide arrangements lying underneath the seat, whose direction of translation is inclined at an angle that lies within a preferred range of angles away from the vertical.

Such a telescopic linear slide arrangement results in a limited movement of the knee joint and limited rotation of the tibia during translation.

The preferred range of angle of inclination is between 8 and 38 degrees from the vertical, and the most preferred angle is 23 degrees from the vertical.

In order to enable the user to effect the translation of the seat relative to the frame on the linear slide mechanism, a translating force, parallel to the direction of movement of the slide is required. Preferably, this force is provided by the user as he pushes down on the arm rests with his hands and an assisting component provided by an assisting mechanism.

The assisting component may be provided by two primary gas struts connected effectively in series between the frame work and the chair with an intermediate connecting plate mounted on a separate slide. The primary gas struts provide a force generally parallel to the direction of motion defined by the linear slide.

A known feature of gas struts is that the force they react decreases as they extend and it would be highly desirable to achieve a substantially constant force as the mechanism is extended.

In addition to the primary gas struts therefore, a secondary gas strut may be provided to compensate for the effect of the diminishing force created by the primary gas struts as they extend. The secondary gas strut may be mounted in between the frame and the seat, away from the centre line of the linear slide such that the component of the force parallel to the direction of translation, provided by the secondary gas strut, increases as the primary gas struts extend and the force they apply decreases, as the seat is moved to the elevated position. This effect can be seen in FIG. 6.

In FIG. 6, the forces parallel to the direction of motion of the slide are shown for the primary and secondary gas struts for different positions between the seated and elevated stances. The cumulative effect of these forces is also shown.

With this arrangement, in order to effect the translation from seated to mounted stance, the user provides an actuating force, usually by pushing down on the frame, a component of which is preferably parallel to the direction of the linear slide, of a magnitude such that together with the assisting force, the combination overcomes the component of the weight parallel to the direction of translation supported by the linear slide. Thus, for example, where the component of the weight supported by the mechanism parallel to the direction of motion is say 700 Newtons, the assisting mechanism could provide a force of say 600 Newtons and the user marginally in excess of 100 Newtons in order to effect the translation. Thus a relatively low force is required from the user to translate from the seated to mounted stance.

Once the translation has been effected, a catch may engage to hold the seat in the elevated position. In this way the user does not have to constantly apply a force to maintain the mounted stance.

In order to move from the mounted to the seated stance, the user releases the catch and the gas struts retract as the seat and user lowers to the seated position due to the effect of gravity on the mass. The gas struts serves to provide a smooth slower translation than would have been experienced if the gas struts were not there, and also serve to collect a substantial amount of the potential energy of the mass of the user, seat and structure as it falls. The energy is collected and stored in the form of compressed air in the gas struts. This energy is used to assist the lift motion next time the chair needs to be elevated.

In the seated position a catch may engage to ensure that the lift mechanism does not actuate as the weight of the user is removed from the seat as the user gets out of the chair. The catch is released before the push down force is applied so that the mechanism can be actuated.

The seat may be configured so that the user can comfortably use it with his or her femur oriented at an angle between at least horizontal and at least 45 degrees down from the horizontal. This type of seat is known as a saddle seat.

As the mechanism of the invention allows the user to quickly and easily raise and lower himself to and from the two positions with minimal effort, it is very convenient for the user to raise himself whenever he needs to perform a task at an elevated height and then to lower himself quickly and conveniently back to the seated position in which configuration the wheelchair can be manoeuvred like other wheelchairs. In the seated position, the stability of the wheelchair of the invention is comparable with that of conventional wheelchairs.

In the mounted stance the majority of the weight of the user is reacted through the saddle type seat whilst the legs are bent making it easier for the user to get closer to people and objects.

### BRIEF DESCRIPTION OF THE DRAWINGS

In the drawings, which illustrate by way of example one embodiment of a wheelchair with an elevating seat according to the invention:

FIG. 1 shows a wheelchair with the seat in the lowered “seated” position;

FIG. 2 shows the wheelchair with the seat in the elevated “mounted” position;

FIG. 3 is a diagrammatic representation of the lifting mechanism in the seated position;

FIG. 4 is a diagrammatic representation of the lifting mechanism in the mounted position;

FIG. 5 is a cross-section through a translating mechanism forming part of the lifting mechanism illustrated in FIGS. 3 and 4;

FIG. 6 is a graph indicating the forces induced in the lifting action;

FIG. 7 is an end view of the translating mechanism;

FIG. 8 shows plan and end views of a telescopic slide used in the translating mechanism;

FIG. 9 shows a wheelchair with the seat in the lowered “seated” position;

FIG. 10 shows a wheelchair with the seat in the elevated “mounted” position;

FIG. 11 is illustrates a person in the “seated” and “mounted” positions;

FIG. 12a is front view of a seat mounting arrangement of a wheelchair according to a second embodiment of the invention;

FIG. 12b is a cross-sectional elevation on A-A of the seat mounting arrangement illustrated in FIG. 12a;

FIG. 13a is a side view of a telescopic slide, in an extended state, forming part of the seat mounting arrangement illustrated in FIGS. 12a and 12b;

FIG. 13b is a bottom plan view of the telescopic slide illustrated in FIG. 13a;

FIG. 14a is a side view of the telescopic slide illustrated in FIG. 13a in a retracted state;

FIG. 14b is a bottom plan view of the telescopic slide illustrated in FIG. 14a;

FIG. 15a is a side view of a person, in the seated position, in a wheelchair having a seat mounting arrangement as illustrated in FIGS. 12 to 14;

FIG. 15b is the side view of FIG. 15a with the person preparing to move to the mounted position;

FIG. 15 is a side view of a person, in the mounted position, in a wheelchair having a seat mounting arrangement as illustrated in FIGS. 12 to 14; and

FIG. 16 is a detailed side view of the seat mounting arrangement forming pat of the wheelchair illustrated in FIGS. 15a to c.

### DETAILED DESCRIPTION OF THE ILLUSTRATED EMBODIMENT

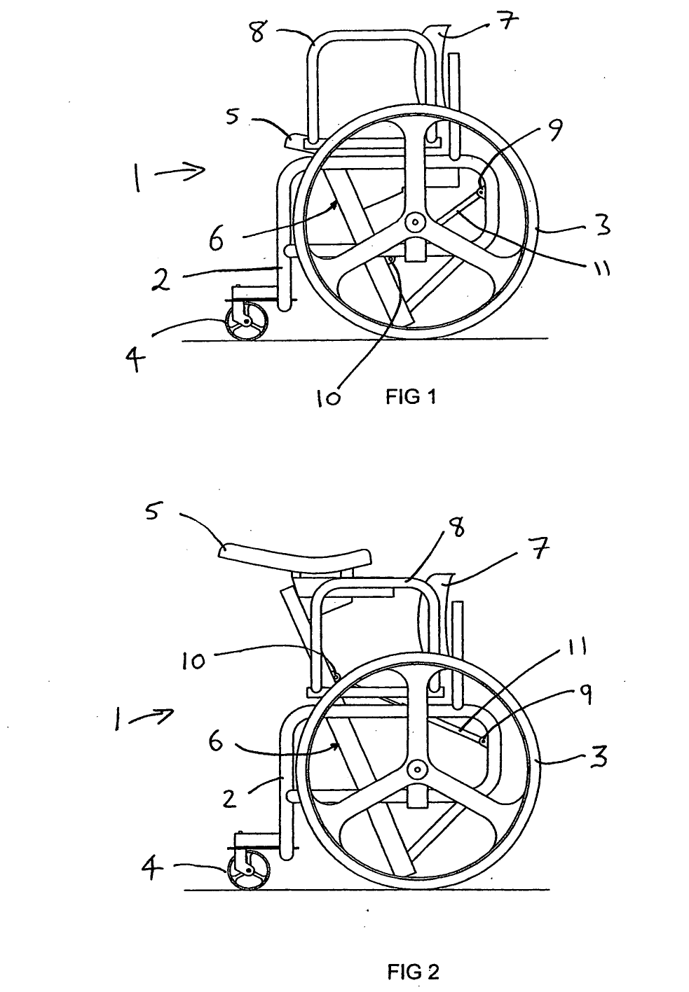

Referring now to FIG. 1, a wheelchair 1 comprises a frame 2. To the rear of the frame 2 are mounted a pair of large diameter spaced apart wheels 3, each wheel of the pair being mounted on a respective side of the frame 2. To the front of the frame 2 is mounted a pair of small diameter wheels 4, each wheel of the pair being mounted on a respective side of the frame 2.

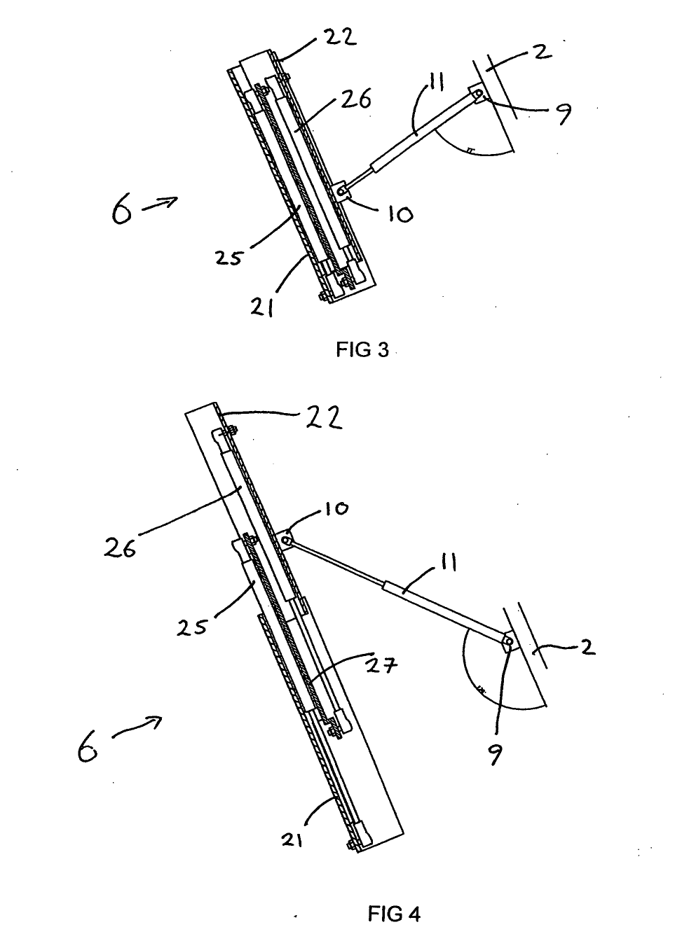

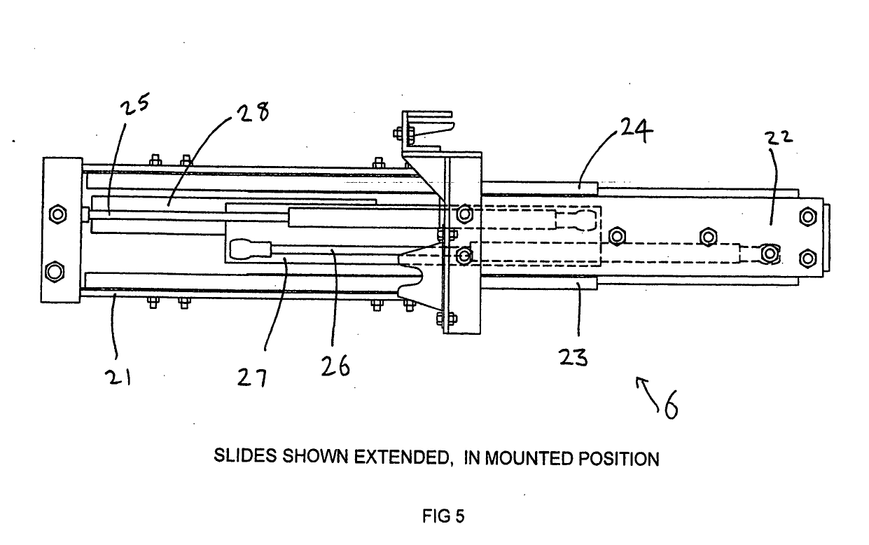

A saddle type seat (referred to hereafter as “a seat”) 5 is mounted on the frame 2 by means of a translating mechanism 6 (described in greater detail with reference to FIGS. 3 and 4). To the rear of the saddle type seat 5 is a back rest 7. It can be seen from FIG. 2 that the backrest 7 does not move with the saddle type seat 5 when the said seat moves into an elevated position.

The frame 2 also mounts side guards 8 located to either side of the seat 5. These guards have a number of purposes. For example, the side guards 8 provide an object against which a person sitting in the wheelchair can push against to raise himself to the standing position. They also protect a person sitting in the wheelchair from the wheels 3.

Extending between a bracket 9 located on the frame 2, and a bracket 10 located on the translating mechanism 6 is a secondary gas strut 11.

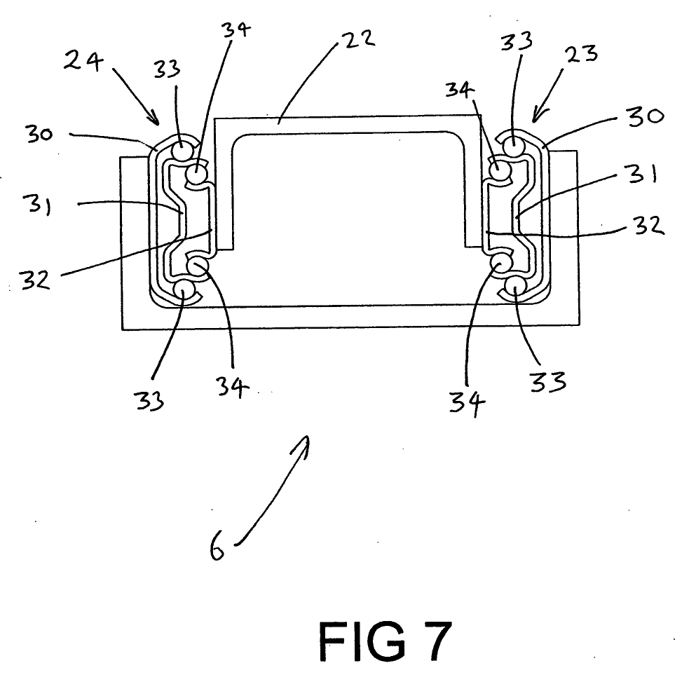

FIGS. 5 and 7 illustrate in detail the translating mechanism 6. The translating mechanism 6 consists of a slide arrangement comprising two channel member 21 and 22 (which in the example are formed from aluminium), arranged such that piece 22 slides within piece 21. With reference to FIGS. 1 to 4, the free end of the channel member 21 is attached to the frame 2 of the wheelchair 1, whilst the free end of the channel member 22 is attached to the seat 5. The channel members 21 and 22 are connected together along their flanges by means of telescopic slides 23 and 24 providing for the channel members 21, 22 to slide backwards and forwards relative to each other.

The channel member 21 mounts a slide element 28 upon which a connector plate 27 is mounted to slide back and forth along the axis of the channel member 21. A pair of primary gas struts 25, 26 supply an actuating force to assist in the actuation of the translating mechanism 6. One end of one of the gas strut 25 is attached to the frame end of the channel member 21 and the other end of the same gas strut is attached to the end of the connector plate 27 most distant from the frame end of the channel member. One end of the other gas strut 26 is attached to the seat end of the channel member 22 and the other end of the same gas strut is attached to the end of the connector plate most distant from the seat end of the channel member 22.

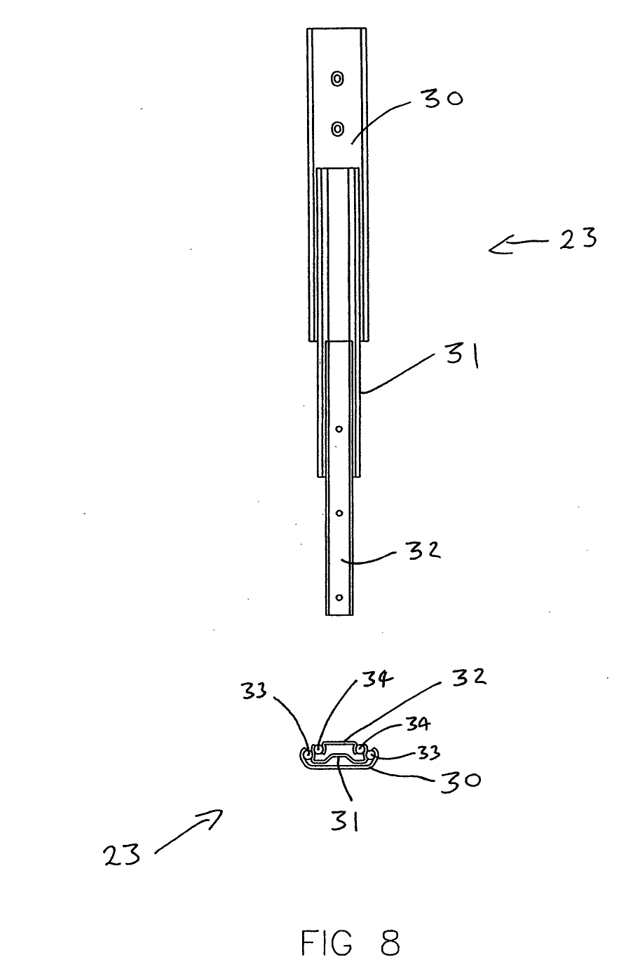

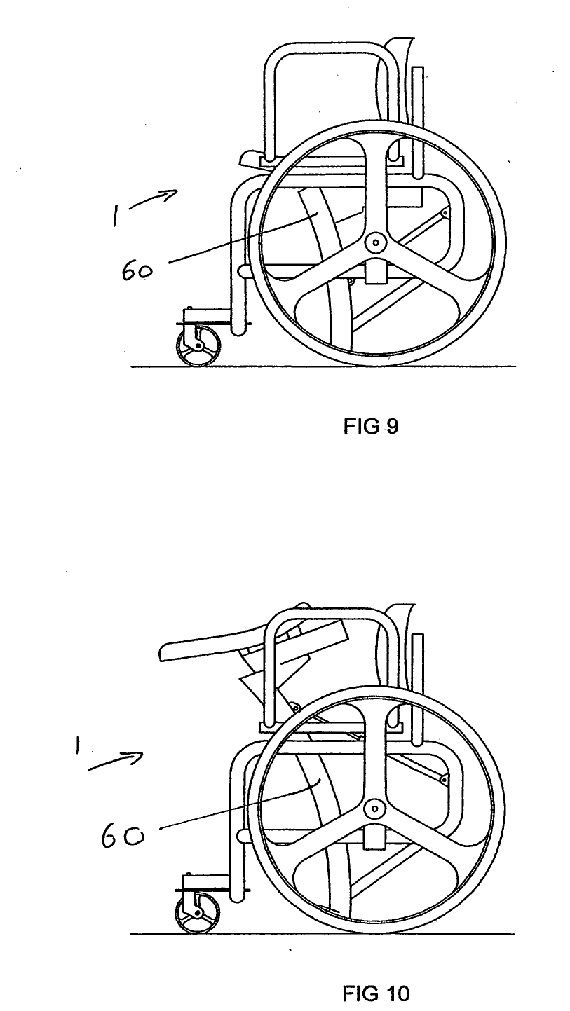

Referring now to FIGS. 7 and 8, the telescopic slides 23 and 24 each comprise three elements 30, 31 and 32. The elements 30 and 31 slide with respect to each other by virtue of ball bearings 33 located between edges of the said elements. The elements 31 and 32 slide with respect to each other by virtue of ball bearings 34 located between edges of the said elements.

Referring now to FIGS. 3 and 4, in FIG. 3, the translating mechanism 6 is illustrated in its retracted state, corresponding to the seat lowered position illustrated in FIG. 1. In the retracted state the channel member 22 is almost fully retracted into the channel member 21, and the primary gas struts 25, 26 are retracted. The secondary gas strut 11 extending between the frame 2 and the translating mechanism 6 is in its retracted position forms an acute angle of 77 degrees with the frame 2.

In FIG. 4, the translating mechanism 6 is illustrated in its extended state, corresponding to the seat raised position in FIG. 1. In the extended position the channel member 22 extends almost fully beyond the end of the channel member 21, and the primary gas struts 25, 26 are both fully extended.

The secondary gas strut 11 extending between the frame 2 and the translating mechanism 6 is in its retracted position forms an obtuse angle of 138 degrees with the frame 2.

For the sake of clarity, in FIGS. 3 and 4, in the illustration of the translating mechanism 6 the telescopic slides 23, 24 are omitted.

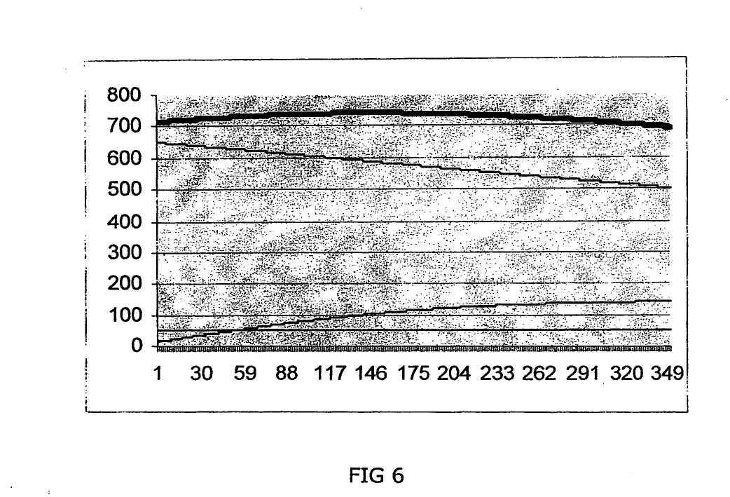

FIG. 6 is a graph illustrating the components of the forces parallel to the direction of motion of the linear slide generated by the primary and secondary gas struts, and these force in combination. The lower plot represents the force generated by the secondary gas strut 11. It can be seen that over the first few millimetres of extension the translating mechanism the secondary gas strut generates low and a negative force. This is because during the initial extension of the translating mechanism the gas strut must be compressed (see FIGS. 3 and 4). The mid plot represents force generated by the two primary gas struts. The force generated starts at 600 N and falls linearly. The upper plot represents the combined force generated by the primary and secondary struts together. This plot is a very shallow curve representing a substantially constant force.

FIGS. 9 and 10 illustrate a wheel chair 1 in which the translating mechanism 60 is slightly curved. Other than the difference in shape of the translating mechanism, the components of the wheelchair shown in FIGS. 9 and 10 are identical to those illustrated in FIGS. 1 and 2.

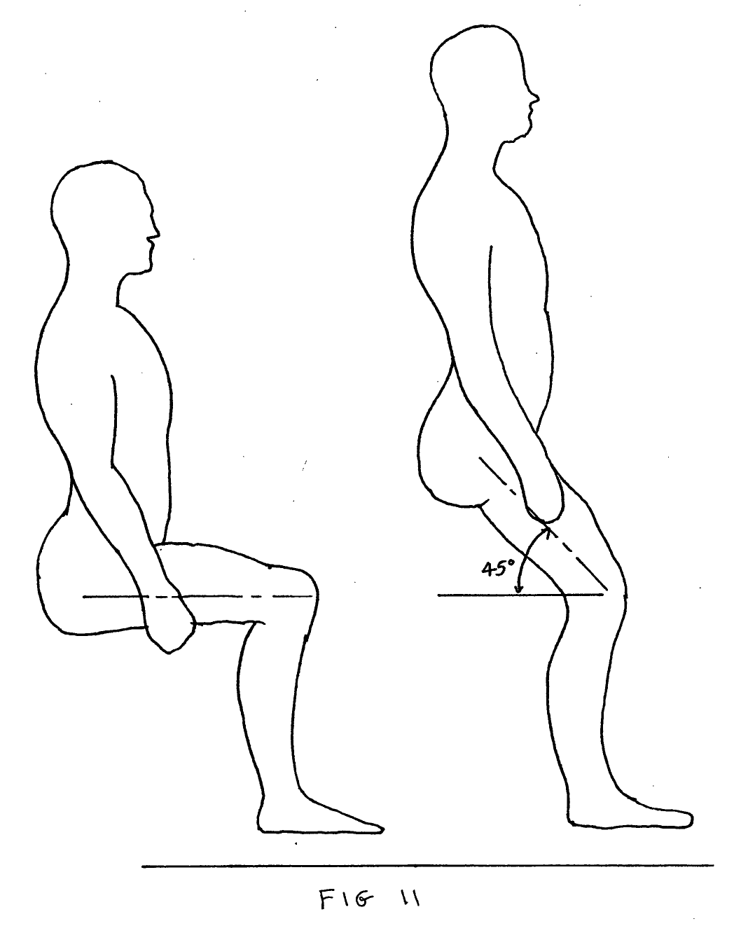

Referring now to FIGS. 12a and 12b, a seat mounting arrangement 70 comprises telescopic slide elements 71, 72 and 73, the first slide element 71 being slidably mounted in the second element 72, with the second element 72 being slidably mounted in a third slide element 73. The first slide element 71 mounts a seat support 74 attached to the slide element by a member 74a, the support 74 comprising two spaced apart brackets 75, each including an aperture 76 for attachment of a seat thereto. The third slide element 73 includes spaced apart brackets 77 and 79 for attaching the telescopic slide arrangement 70 to the chassis of the wheel chair. The bracket 79 includes plates 80 which are provided with apertures through which bolts 81 can be passed to attach the seat mounting arrangement 70 to the lower part of a chassis of a wheelchair. Similarly, the bracket 77 is provided with apertures through which bolts 78 are passed to attach the upper part of the third slide member to the said chassis.

The second slide element 73 mounts a plate 82. Respective ends 88 and 93 of first and second gas struts 86 and 90 are attached to the plate 82, the end 92 of the gas strut 90 being attached to the lower end of the third slide member 73 and the end 87 of the gas strut 86 being attached to the seat mount end of the first slide member 71.

The force generated by the gas struts 86 and 90 is substantially the same. Connecting the gas struts 86 and 90 in series results in the first member 71 moving by the sum of the distances moved by the gas struts 86 and 90. If the gas struts 86 and 90 are at the same pressure, the second slide member 72 moves at half the speed of the first slide member 71.

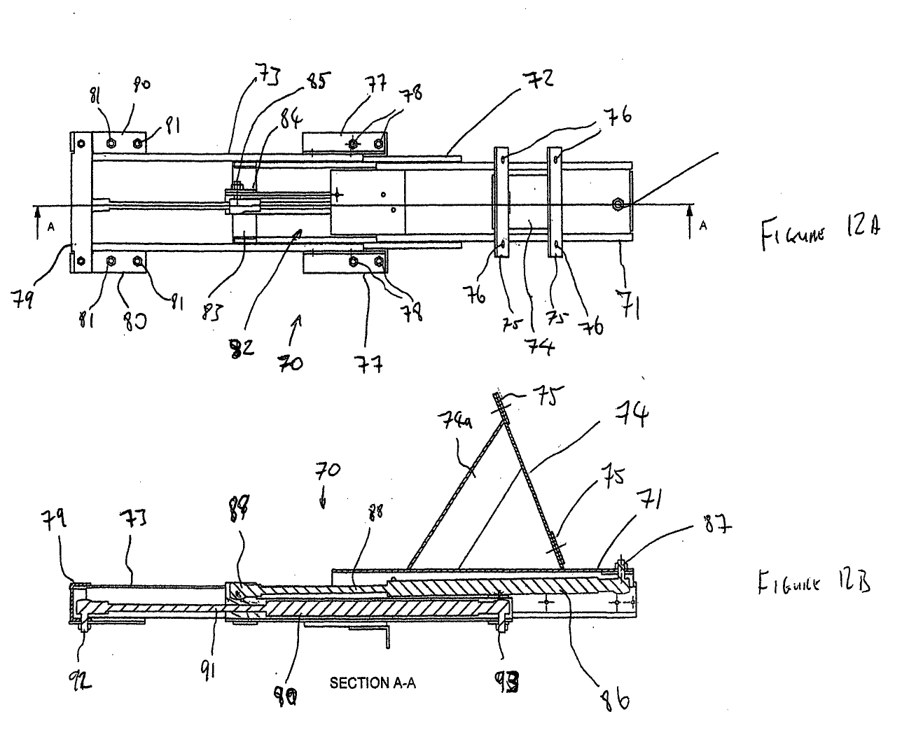

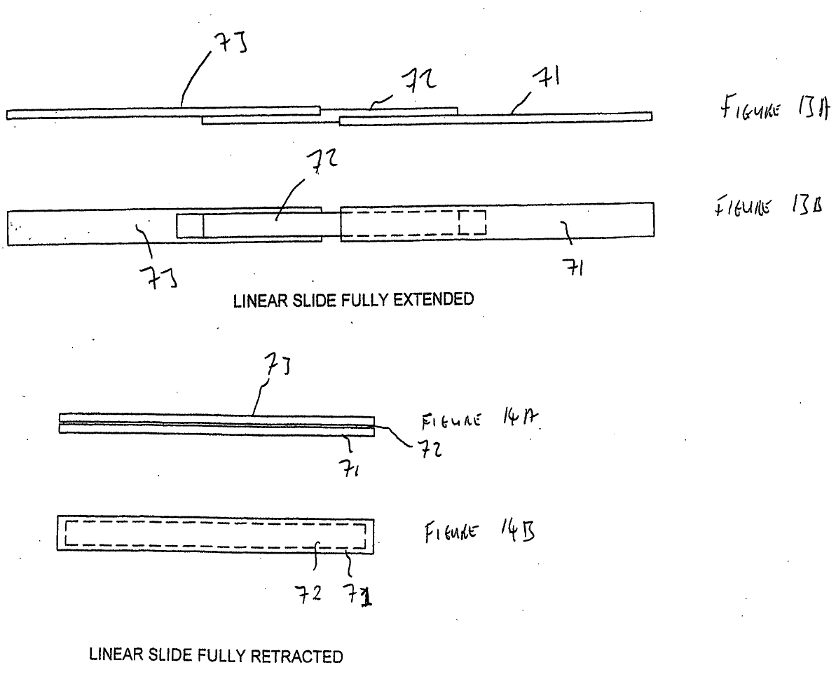

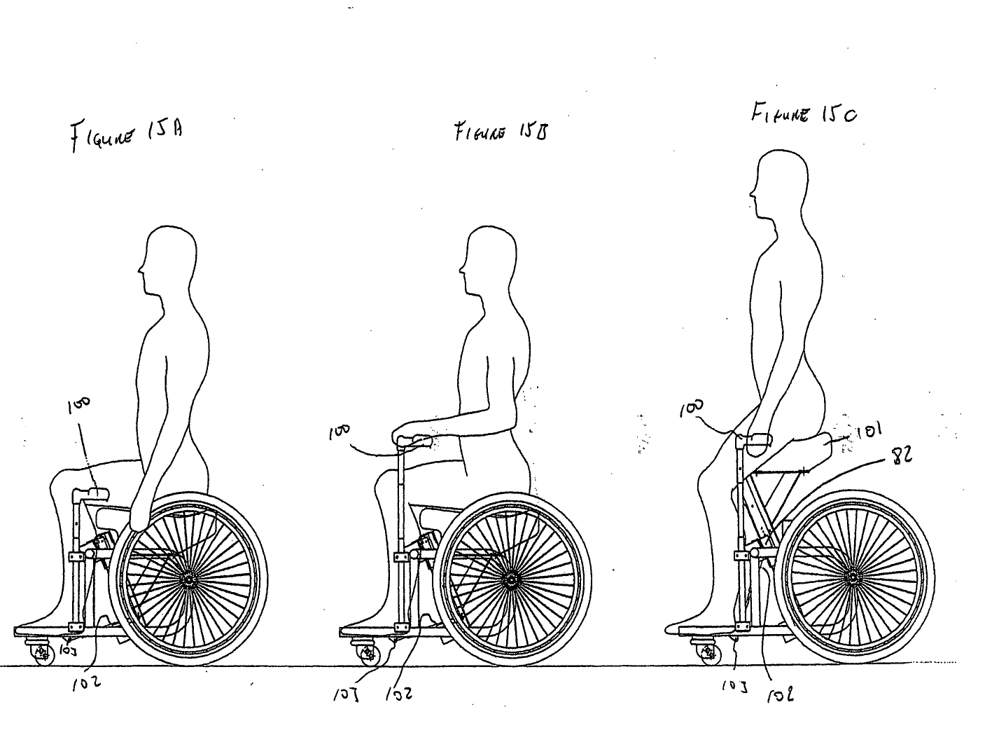

FIGS. 13a to 14b illustrate the simple nature of the telescopic slide forming part of the seat mounting arrangement 70 illustrated in FIGS. 12a and 12b.

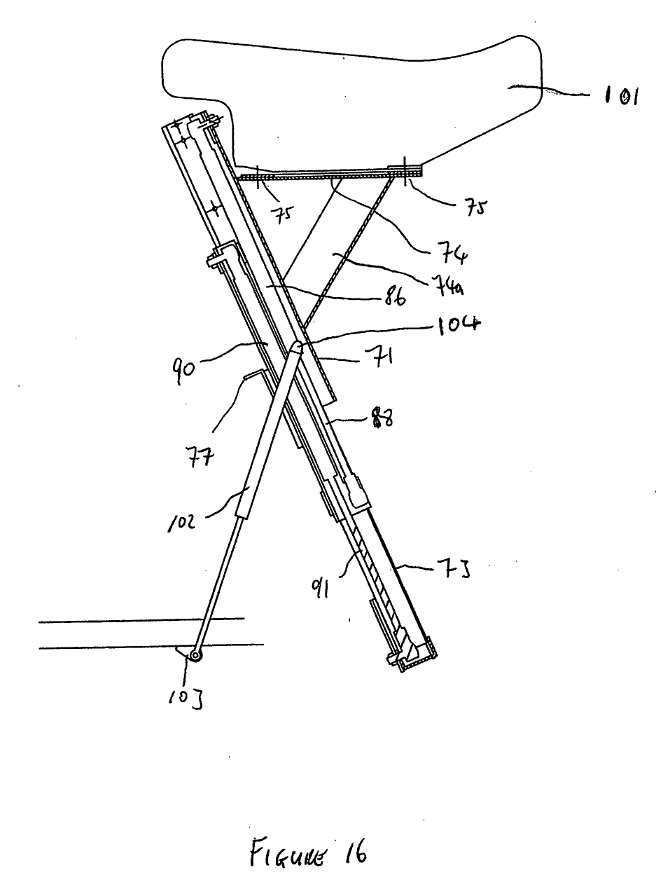

Referring now to FIGS. 15a to 15c, from the seated position in FIG. 15a, the user extends the handles 100 to a convenient height, as shown in FIG. 15b, and then pushes gently on the handles allowing the gas struts to force the seat 101 upward to the position illustrated in FIG. 15c. In addition to the gas struts 86 and 90, a third gas strut 102 is provided extending between an attachment point 103 located on the wheelchair chassis, and the telescopic slide element 71, which mounts the seat 101.

In FIGS. 15a and 15b, the strut lies close to horizontal, and at substantially 90 degrees to the longitudinal axis of the seat mounting arrangement illustrated in FIGS. 12 to 14. The gas strut 102 generates a force component aligned with the longitudinal direction of the said seat mounting arrangement. In the condition illustrated in FIGS. 15a and 15b the said force component is very small.

In FIG. 15c, the seat 101 is raised and the strut 102 extends almost vertically thereby contributing significantly to the force lifting the seat (see FIG. 6) when the force generated by the gas struts 86 and 90 is diminishing.

Referring now to FIG. 16, which illustrates the seat of the wheelchair in FIGS. 15a to 15c shows how one end of the secondary gas strut 102 is attached to a bracket 103 forming part of the wheelchair frame, whilst the other end of the gas strut is attached at a point 104 to the telescopic slide element 71. In fact, the gas strut 102 may be attached to the telescopic slide element 71, to a part attached to the slide element 71, such as the seat mount 74 or the member 74a.

1. Apparatus for moving a seat of a wheelchair between lowered and raised positions, the apparatus comprising a translating mechanism having a first end and a second end, wherein the first end of the translating mechanism is attached to a frame of the wheelchair and the seat is attached to the second end of the translating mechanism, and wherein the translating mechanism generates a translational movement of the seat that is forwards and upwards with respect to the frame of the wheelchair, further comprising assist means, wherein the said assist means generates a force substantially parallel to the direction of translation of the said seat, and the said force is substantially constant throughout the translation of the seat between lowered and raised positions.

2. Apparatus according to claim 1, wherein the translating mechanism is inclined at angle between horizontal and vertical axes.

3. Apparatus according to claim 2, wherein the angle of inclination of the translating mechanism is in the range of 8 to 38 degrees with respect to the vertical.

4. Apparatus according to claim 3, wherein the angle of inclination of the translating mechanism is substantially 23 degrees.

5. Apparatus according to claim 1, wherein the translating mechanism generates a linear translational movement of the seat.

6. Apparatus according to claim 1, wherein said force component is one of: marginally less than a force acting opposite to said force component, said force being the sum of the components of the weight of a person sitting in the wheelchair that is supported by the seat and the weight of elements of the apparatus both resolved parallel to the direction of translation of the translating mechanism; marginally greater than a force acting opposite to said force component, said force being the sum of the components of the weight of a person sitting in the wheelchair that is supported by the seat and the weight of elements of the apparatus both resolved parallel to the direction of translation of the translating mechanism; at the seat lowered position marginally greater, and at the seat raised position marginally less than a force acting opposite to said force component, said force being the sum of the components of the weight of a person sitting in the wheelchair that is supported by the seat and the weight of elements of the apparatus both resolved parallel to the direction of translation of the translating mechanism; and at the seat lowered position marginally less, and at the seat raised position marginally greater than a force acting opposite to said force component, said force being the sum of the components of the weight of a person sitting in the wheelchair that is supported by the seat and the weight of elements of the apparatus both resolved parallel to the direction of translation of the translating mechanism.

7. Apparatus according to according to claim 6, wherein the difference between the said force component and the combined weight of a person sitting on the seat and elements of the apparatus generating a force opposite to said force component is about 100 N.

8. Apparatus according to claim 1, wherein the potential energy released during movement of the seat from the raised position to the lowered position is collected by the said assist means.

9. Apparatus according to claim 1, wherein the said assist means includes a primary assist means aligned substantially parallel to the direction of translation of the seat and generating a force component substantially parallel to the said direction of translation of the seat.

10. Apparatus according to claim 9, wherein the magnitude of the force component is greater with the seat in the lowered position than in the raised position.

11. Apparatus according to claim 9, wherein the said assist means further comprises secondary assist means extending between the frame of the wheelchair and the said translating mechanism and aligned at angle to the said direction of translation of the seat, the secondary assist means generating a force component substantially parallel to the said direction of translation of the seat.

12. Apparatus according to claim 11, wherein the said angle of alignment with the seat in the lowered position is such that the force component parallel to the direction of translation is small, and wherein the said component of force increases as the seat moves from the lowered to the raised position.

13. Apparatus according to claim 12, wherein with the seat in the lowered position the said force component acts parallel to and opposite to the said direction of translation moving from the lowered to the raised position.

14. Apparatus according to claim 12, wherein the magnitude of the force component generated by the secondary linear assist means with the seat in the raised position is substantially similar to the difference between the force generated by the primary linear assist means in the lowered and raised positions.

15. Apparatus according to claim 1, wherein the translating mechanism consists of a telescopic slide having a plurality of slide members, one endmost slide member being attachable to the wheelchair chassis, and the other endmost slide member mounting the seat, wherein at least one slide member mounts a bracket movable with the said one telescopic slide member, and wherein the assist means comprises at least two linear actuators, one end of each liner actuator being attached to the said bracket, the other end of one of the linear actuators being attached to the wheelchair chassis, and the other end of another of the at least two linear actuators being attached to the slide member mounting the seat, and wherein the first and second linear actuators exert a force substantially parallel with the axis of translation of the said mechanism.

16. Apparatus according to claim 15, comprising a further linear actuator, one end of the actuator being attached to the chassis at a point spaced apart from the translating mechanism, the other end being attached to the seat mount.

17. Apparatus according to claim 16, wherein the actuator is attached to any one of: a telescopic slide element mounting the seat; a bracket mounting the seat; and the seat.

18. Apparatus according to claim 1, wherein the translating mechanism includes two elongate members arranged to slide one within the other.

19. Apparatus according to claim 18, wherein one end of one of the elongate members is connected to the seat and one end of the other elongate member is connected to the frame.

20. Apparatus according to claim 18, wherein one elongate member is supported within the other by a telescopic slide, the telescopic slide comprising a plurality of elements slidable with respect to each other.

21. Apparatus according to claim 18, wherein the two elongate members are components of a telescopic slide, the telescopic slide comprising a plurality of elements slidable with respect to each other.

22. Apparatus according to claim 9, wherein the primary assist means consists of a pair of linear actuators, each actuator having first and second ends, and wherein the first end of one actuator of the pair is connected to one end of a plate slidably mounted with respect to one of the elongate members and the second end of that actuator is connected to one of the elongate members, and the first end of the other actuator is connected to the plate and the second end of that actuator is connected to the other elongate member.

23. Apparatus according to claim 22, wherein the said plate is any one of: slidably mounted within one of the elongate members; slidably mounted without one of the elongate members; and an element of the telescopic slide.

24. Apparatus according to claim 22, wherein the first end of one of the actuators is mounted on the elongate member connected to the frame, in close proximity to the connection of said member to said frame, and the second end of the actuator is connected to the end of the plate most distant from the frame, and the first end of the other actuator is mounted on the elongate member connected to the seat, and in dose proximity to the connection of said member to said seat, and the second end of the actuator is connected to the end of the plate most distant from the seat.

25. Apparatus according to claim 9, wherein the said primary and secondary assist means comprise any one of: a linear assist means; a linear actuator; and a linear actuator selected from the group of actuators comprising: a gas strut, a coil spring, a helical spring in combination with a rack and pinion, a hydraulic cylinder and gas filled accumulator combination.

26. Apparatus according to claim 1, wherein the seat is a saddle seat.

27. A wheelchair comprising apparatus as claimed in claim 1.
